(19) United States
(12) Patent Application Publication
(10) Pub. No.: US 2018/0202907 A1
(43) Pub. Date: Jul. 19, 2018

(54) SYSTEM FOR CONCENTRATION AND PRE-CONCENTRATION BY SAMPLE STACKING AND/OR PURIFICATION FOR ANALYSIS

(71) Applicant: PICOMETRICS TECHNOLOGIE, Labege (FR)

(72) Inventors: Frederic GINOT, Labege (FR); Comtet-Louis ANDRIAMANAMPISOA, Labege (FR); Vincent PICOT, Labege (FR); Audrey BOUTONNET, Labege (FR); Aurelien BANCAUD, Toulouse (FR)

(21) Appl. No.: 15/743,313

(22) PCT Filed: Jul. 11, 2016
(86) PCT No.: PCT/FR2016/051774

§ 371 Date: Jan. 10, 2018

(30) Foreign Application Priority Data
Jul. 10, 2015 (FR) 1556605
Nov. 4, 2015 (FR) 1560595
Mar. 11, 2016 (FR) 1652079

(51) Int. Cl. G01N 1/40; G01N 27/447; G01N 30/00

(52) U.S. Cl. CPC G01N 1/40; G01N 27/44756; G01N 2030/004; G01N 2001/4038; G01N 30/0005

(57) ABSTRACT

The invention relates to a system (700) for treating molecules or particles of interest carried by a viscoelastic liquid, which comprises:
a means (715) for establishing a laminar flow, during at least one portion, referred to as “concentration phase”, of the operating time of the system, of the viscoelastic liquid in a concentration, stacking and/or purification device (705), said device comprising a concentration area having, in the direction of said flow, an intake cross-section surface that is larger than the cross-section surface of each outlet channel, and
a means (725) for applying an electric field between the intake and the outlet of the concentration area during the concentration phase, the action of the electric field on the molecules or particles of interest being, in the concentration area, opposite to the direction of said flow and causing the molecules or particles of interest to be retained at least in the concentration area;
   which also comprises a modulation means (730) configured to control the means for applying the electric field in order to apply, after the concentration phase, an electric field with intensity other than zero and lower than the intensity of the electric field applied during the concentration phase.

### TECHNICAL FIELD OF THE INVENTION

The present invention relates to a system for concentration and pre-concentration by sample stacking and/or purification for analysis or for preparing chemical or biological samples. It applies, in particular, to the in-line concentration, pre-concentration (“stacking”) and purification upstream from analysis preparation instruments or analysis instruments, for example by capillary electrophoresis.

### STATE OF THE ART

In analytical chemistry or in vitro biological analysis, a sample very frequently needs to be concentrated and purified before it is analyzed.

Therefore, an analysis by capillary electrophoresis requires samples that are sufficiently pure and concentrated. Capillary electrophoresis is an analytical technique that enables high separation efficiency for small and large molecules. The capillary electrophoresis instrument consists of a fused silica capillary with a detection window, a high voltage source, two electrodes, two buffer tanks and an optical absorbance or fluorescence detector.

After filling the capillary with buffer solution, the sample is injected at the capillary intake. Voltage is applied to the terminals of the capillary. The molecules are then separated by an electroosmotic and electrophoretic flow.

To increase the sensitivity of the analysis, laser-induced fluorescence (LIF) or light-emitting diode-induced fluorescence (LEDIF) detection is often used, in which the analyte is marked by a fluorochrome that is detected and/or quantified by induced fluorescence. This detection technique is more sensitive and more selective that the conventional detection by UV absorbance. This is because only the chemically derived or naturally fluorescing molecules are detected.

Another way to increase the sensitivity of the analysis, with or without laser-induced or light-emitting diode-induced fluorescence detection, is to use in-line pre-concentration techniques, also called “stacking”. The technique of pre-concentration by sample stacking (better known to the person skilled in the art as “stacking” and referred to below as “stacking”) used most frequently (Field-Amplified Sample Stacking) is based on a difference in conductivity between the analysis buffer and the sample. The fact of diluting the sample in water before injection, instead of in the buffer, results in a frontal accumulation of the sample and contributes to obtaining higher, shorter peaks, and therefore better analysis sensitivity and better resolution. There are other in-line pre-concentration techniques for capillary electrophoresis. They almost all need to have fine control over the ion content of the sample, which can require purifying the sample beforehand.

Document US 2008/0087546 describes a technique for the in-line concentration and separation of electrically charged analytes. This technique is based on focusing molecules where an electrical force and a hydrodynamic flow are balanced in a field gradient caused by a change in cross-section along the axis of flow. In this technique, the electric field gradient and the hydrodynamic flow gradient need to be different so that the molecules of interest accumulate at the balance point. However, in a channel formed of solid, insulated walls, if a voltage and pressure are applied to the two ends of the channel filled with an electrolyte, the speed of the hydrodynamic flow and the electric field, and therefore the electrical force applied to the molecule, both vary in inverse proportion to the cross-section of the channel. To introduce a difference between these two force gradients, the invention introduces an electrode chamber separated from the concentration/separation chamber by a semi-permeable membrane which makes it possible, thanks to the individual control of electrodes, to apply an electric field gradient that differs from the hydrodynamic flow gradient in the concentration/separation chamber. Alternatively, the electrodes are placed directly in the concentration/separation chamber. This technique is elegant, but makes it much more complicated to manufacture the device and to remove the bubbles formed at the electrodes when the electric field is applied.

Document US 2005/0034990 also describes a method of concentrating charged analytes by a balance between an electrical force driving the analyte, and a hydrodynamic counterflow, which counterflow is itself induced indirectly by the applied electric field thanks to the electroosmosis phenomenon. The flow channel must therefore contain at least one charged wall of the same sign as the analyte to cause this flow. In order to obtain a hydrodynamic flow gradient, the concentration device is formed of a flow channel going from a large cross-section to a small cross-section. The analyte advances under the effect of the electrical force in the large cross-section channel, but is blocked by the rapid hydrodynamic flow exiting from the small cross-section channel. However, the device does not describe a clear means for making the hydrodynamic flow gradient and the electric field gradient vary in a dissimilar way according to the flow cross-section, as described above. The concentration phenomenon is therefore unstable, difficult to control and requires, for physical reasons not fully understood, the use of very small channels, less than 5 μm, preferably less than 1 μm.

Document FR 3 024 544 also proposes an in-line concentration method based on a balance between a hydrodynamic drive and an electrical counter-force. This method must necessarily take place in a channel sufficiently narrow for the flow to be laminar and with significant shear at the scale of the molecules or particles to be concentrated. In addition, the carrier fluid must be viscoelastic. The molecules to be analyzed are in this flow. When an electric field is applied that generates a force opposite to the flow direction, the electrically charged molecules are subjected to a counter-electrophoresis and move at a slower speed than the fluid surrounding them. As a result of this, the molecules deform the flow in their neighboring area. Because of the not-insignificant shear at the macromolecule scale and because of the viscoelastic properties of the fluid, the flow exerts a counter-reaction on the molecules, perpendicular to the flow, which pushes the molecules towards the walls. The intensity of the force depends on the nature of the fluid, the shear rate, the size of the molecule and the intensity of the electrophoresis force, and therefore the electric field applied. In a channel with a constant cross-section, the molecules are therefore distributed along an axis transversal to the flow, according to their size. In a laminar flow, the speed of the flow depends on the position. The molecules are thus propelled by the flow at different speeds and are therefore separated according to their size. This separation technique has been applied in particular to the separation of DNA fragments.

By choosing the geometry of the laminar flow, conditions can also be created whereby the molecules of interest are stopped at a specific point in the device, even though the flow of the sample is still present. In this way, these molecules can be concentrated in line, then analyzed or purified. The analysis is carried out with very high sensitivity because of the concentration achieved by the device.

For example, for a channel having an intake cone forming a bottleneck, with a linear reduction from the largest dimension of the cross-section perpendicular to the flow direction, the progressive restriction generates an acceleration of the fluid, and therefore of the shear, and an increase in the electric field opposing the flow. Therefore, in the direction in which the cross-section of the channel decreases, the transversal force increases as the restriction comes closer. When the molecules are at a distance from the wall such that their speed linked to the flow is equal to their electrophoresis speed in the opposite direction, the molecules stop, even though the flow is still present. There is therefore an accumulation of molecules at this place, and therefore concentration. It is noted that the Brownian motion causes a random distribution in the parabolic profile of the flow. The initial viscoelastic transversal force modifies the barycenter of the cluster of points, packing the molecules towards the wall.

It is noted that this method makes it possible not only to concentrate the molecules, but also possibly to separate them. The separation depends on each channel's restriction geometry: a long cone, with a low angle, distributes the molecules according to their size over a greater length than a short cone with a high angle.

It is also noted that this method constitutes a low-pass filter as well: all the molecules below a certain size or a certain charge pass freely in the channels.

But, as mentioned above, this method must necessarily take place in a channel having a sufficiently small dimension, which limits the sample volume that can be treated. In addition, this method's separation power is mediocre, since it is limited by the length over which the restriction of the channel's cross-section took place.

The state-of-the-art techniques for increasing the sensitivity of the analysis are not always sufficient to avoid having to concentrate the sample prior to an analysis. The chemist or biologist must therefore concentrate the sample ahead of the analysis, often manually. Thus, in molecular biology or immunology, there are many manual kits for purifying and concentrating the sample before analysis. These off-line purification and concentration steps are long and time-consuming, sometimes costly, and contain a risk of the sample being lost or deteriorated during the operations.

This problem of the purity of samples and their concentration is a general problem for analysis in chemistry or biology. It is present for all analyses, such as gel electrophoresis, chromatography, optical analyses (spectral, chiral, fluorescence, absorption, turbidity, etc), mass spectrometry, homogeneous binding tests, such as immunoanalyses, electrochemical tests, DNA sequencing, etc. Whatever the analyses, it is often advantageous to have an in-line pre-concentration method for samples, which works even with non-purified, or weakly purified samples. Otherwise, the operator must utilize purification and/or concentration methods ahead of the analysis, with the drawbacks already mentioned above in the case of capillary electrophoresis.

The purity and concentration of biochemical or biological products is also a problem that is encountered in the bio-production of active substances for health. In this type of production, one begins with a large volume of product, for example a volume of cells containing the product of interest, suspended in their culture medium, and one wants to obtain, at the end of the process, the extremely pure therapeutic product in a volume typically 100-1000 times smaller than the starting volume. The process generally consists of several steps, which depend on the therapeutic product to be purified. Very often, the first steps include one or more chromatographs, which allowing the product to be both purified and concentrated in part. Very often, as well, the last step is an ultra-filtration for concentrating the purified product. In these processes, the yield and speed of each step are key control criteria for the development of the industrial-scale process. Multiplying the steps often enables very high product purities to be obtained, but increases the direct and indirect production costs, all the more so since this multiplication of steps reduces the yields. It is therefore advantageous to have processes allowing both purification and concentration within a short time, therefore with a high flow rate.

It should also be noted here that the compromise between the length of the separation system and the separation power of the separation technique is a recurrent problem in the field of analytical chemistry, above all at the preparation scale, which requires large sample volumes to be treated. In analytical chemistry or in vitro biological analysis, the most commonly used separation techniques are electrophoresis techniques and chromatography techniques.

In the electrophoresis techniques, the charged particles or molecules of the sample, which are in solution or in suspension in an aqueous medium, are placed in an electric field. They therefore migrate under the effect of the force induced by the electric field, at a speed that depends on their charge and also on their size. After a certain migration time, and therefore a certain migration distance, the molecules are separated and can be detected separately.

For the analytes, molecules or particles with a size greater than the Debye length, which is the thickness of the ionic layer surrounding the charged analyte to ensure the electroneutrality of the solution, it is solely the charge density that determines the migration speed of the analytes in free solution. To be able to separate molecules that have the same chemical nature, therefore the same charge density, but a different size, a matrix must be introduced, generally in the form of a gel of a neutral hydrophilic polymer, which acts as a molecular sieve. In this way, DNA molecules of different sizes, or proteins, can be separated. Again, the separation occurs after a certain migration time and certain migration distance.

It is clearly understood that, in these techniques, a compromise has to be found between the migration time, migration distance, and resolution of the separation between the sample's different analytes. To reduce the size of the instruments and the analysis times, the electrophoreses can be miniaturized. However, this miniaturization is not possible when one wants to isolate a large amount of analyte by electrophoresis. In this case, the biochemist is obliged to use bulky, slow systems. In addition, there are few preparation systems based on electrophoresis, and those that exist are systems limited to laboratory-scale; there is no preparation of molecules by electrophoresis at a truly industrial scale.

There are many chromatography techniques, which are based on different separation principles.

Like electrophoresis, size-exclusion chromatography is based on a difference of migration speed of molecules, or particles, in a column filled with immobile, porous particles called the chromatography support; the largest analytes, with a size greater than the pores of the support, carried by the flow, advance without being able to enter the particles of the support, in the dead volume of the column. In contrast, the smaller analytes enter the pores of the support, and follow more tortuous paths in it than the large analytes, with a slower hydrodynamic flow. They therefore migrate more slowly along the column. A detector placed downstream from the column therefore first sees the large analytes pass, then the small analytes. There are many different detectors: absorption of UV or visible light, light-scattering, refractive index, fluorescence, conductivity, etc, and mass spectrometry.

In size-exclusion chromatography, there are also the drawbacks of migration length and analysis time already mentioned for the electrophoresis techniques. Another drawback of the method is the fact that it is necessary to find an inert chromatography support, which has no molecular interaction with the analytes of the sample, which is not always possible. Lastly, the solid impurities of the sample must have a size much smaller than the diameter of the chromatography support's particles, to prevent clogging. However, it is advantageous to reduce the size of these supports as far as possible, to improve the yield of these supports, and reduce its length and volume. Nevertheless, there are industrial installations based on this chromatography, for example for purifying therapeutic antibodies in the pharmaceutical industry.

The techniques of ion-exchange or reverse-phase chromatography are based on a difference in adsorption of analytes on the chromatography support. The molecules, or particles, of the sample are placed in a support that causes their adsorption on the particles of the chromatography support; this adsorption has an electrostatic source in ion-exchange chromatography systems, and a hydrophobic source in reverse-phase chromatography systems. Once the analytes are entirely adsorbed in the chromatography column, in general an elution solvent time gradient is applied that will differentially detach the analytes; the analytes with the weakest attachment to the support will be detached first, and will exit first from the chromatography column. The gradient applied is a solvent polarity gradient for reverse-phase chromatography systems, and a pH or salt gradient for ion-exchange chromatography systems.

In these techniques, the compromise to be found between column length, analysis time and resolution are found indirectly. To maximize the resolution, in the application of the gradient the intake to and outlet from the column need to have similar elution conditions; otherwise, the molecules at the column intake detach before those located at the outlet, which reduces the separation power of the chromatography column. Therefore, either a slow gradient or a short column is required. However, if the column is short, the support quantity may not be sufficient to adsorb all the sample's analytes. Also, the shorter the column, the more the flow rate of the sample during adsorption needs to be slow, such that the analytes have the time to be adsorbed on the support. These chromatography techniques also have the same drawbacks of clogging as the techniques of size-exclusion chromatography, and the same difficulty finding supports on which the analytes are only adsorbed by a single molecular interaction.

### Subject of the Invention

The present invention aims to remedy all or part of these drawbacks.

To this end, the present invention relates to a system and method for separating molecules or particles for analysis or for preparing chemical or biological samples. It is in the field of separation sciences, whether for purposes of analysis, of preparing samples, or for the industrial production of molecules or particles.

The separation system and method that are the subjects of the present invention aim to overcome the compromise between the separation device length and analysis time, and accepting solid impurities in the sample much greater than several micrometers. Therefore, rapid separations can be obtained, with a compact device, at the analytical scale and at the preparation scale, for a sample containing debris, for example cellular debris.

According to a first aspect, the present invention relates to a system for treating molecules or particles of interest carried by a viscoelastic liquid, a system that comprises:
a means for establishing a laminar flow, during at least one portion, referred to as “concentration phase”, of the operating time of the system, of the viscoelastic liquid in a concentration, stacking and/or purification device, said device comprising a concentration area having, in the direction of said flow, an intake cross-section surface that is larger than the cross-section surface of each outlet channel;
a means for applying an electric field between the intake and the outlet of the concentration area during the concentration phase, the action of the electric field on the molecules or particles of interest being, in the concentration area, opposite to the direction of said flow and causing the molecules or particles of interest to be retained at least in the concentration area; and
a modulation means configured to control the means for applying the electric field in order to apply, after the concentration phase, an electric field with intensity other than zero and lower than the intensity of the electric field applied during the concentration phase.

Thanks to these provisions, the molecules or particles are, firstly, concentrated in the concentration area, then transferred after the concentration phase: a portion of the molecules or particles of interest retained in the concentration area remain retained until another portion is transferred to an analysis preparation or analysis instrument or simply towards a detector of the state of the art. The molecules or particles of interest are therefore separated according to their type, charge or size.

In some embodiments, the concentration area comprises an intake channel and at least one outlet channel, the average shear present in each outlet channel being at least twice that of the average shear present in the intake channel.

Thanks to these provisions, the particles or molecules of the sample are concentrated in the concentration area upstream from parallel channels, possibly with a separation according to size and electric charge along lines of iso-shear (ie equal shear).

In some embodiments, the modulation means is configured to control the electric field application means to apply an electric field decreasing over time. In this way, the molecules retained in the concentration area during the concentration phase are continually separated according to their type, charge or size.

In some embodiments, the system also comprises the pressure modulation means for applying, after the concentration phase, a different pressure from the pressure applied during the concentration phase.

In some embodiments, the pressure modulation means is configured to apply, after the concentration phase, a higher pressure than the pressure applied during the concentration phase.

In this way, faster separation is obtained.

In some embodiments, the concentration area comprises an open diaphragm perpendicular to the central axis of flow of the viscoelastic fluid in the concentration area.

These embodiments are easy to achieve, for example by binding two capillaries with pathways or channels of different sizes.

In some embodiments, the concentration area comprises a multitude of openings or capillaries parallel to the central axis of flow of the viscoelastic fluid in the concentration area.

These embodiments have the advantage of having a higher flow rate. They can be utilized with more voluminous samples.

In some embodiments, the concentration area comprises an angle, the central axis of flow of the viscoelastic fluid following said angle when passing through the concentration area.

In some embodiments, the system that is the subject of the present invention comprises a valve for orienting the viscoelastic fluid exiting from the concentration area to a choice of two directions, one of said directions leading to an instrument and/or a fraction collector.

These embodiments make it possible to reject the molecules or particles without interest and therefore to purify the sample.

According to a second aspect, the present invention relates to a method for treating molecules or particles of interest carried by a viscoelastic liquid, a method that comprises:
a step of establishing a laminar flow, during at least one portion, referred to as “concentration phase”, of the operating time of the system, of the viscoelastic liquid in a concentration, stacking and/or purification device, said device comprising a concentration area having, in the direction of said flow, an intake cross-section surface that is larger than the cross-section surface of each outlet channel;
at least during the concentration phase, a step of applying an electric field between the intake and the outlet of the concentration area, the action of the electric field on the molecules or particles of interest being, in the concentration area, opposite to the direction of said flow and causing the molecules or particles of interest to be retained at least in the concentration area; and
a step of modulating the electric field in order to apply, after the concentration phase, an electric field with intensity other than zero and lower than the intensity of the electric field applied during the concentration phase.

As the particular features, advantages and aims of this method are similar to those of the system that is the subject of the present invention, they are not repeated here.

According to a third aspect, the present invention relates to a system for treating molecules or particles of interest carried by a viscoelastic liquid, a system that comprises:
a means for establishing a laminar flow, during at least one portion, referred to as “concentration phase”, of the operating time of the system, of the liquid in a concentration, pre-concentration by sample stacking and/or purification device, said device comprising a concentration area having, in the direction of said flow, an intake channel and a plurality of outlet channels; and
a means for applying an electric field between the intake and the outlet of the concentration area during the concentration phase, the action of the electric field on the molecules or particles of interest being, in the concentration area, opposite to the direction of said flow and causing the molecules or particles of interest to be retained at least in the concentration area.

Thanks to these provisions, the cross-section of the intake channel and the number of necks are increased, which makes it possible to increase the concentration phenomenon and the volume of the sample treated, compared to what is described in FR 3 024 544. In this way, the treatment systems that are the subjects of the present invention, which comprise a plurality of channels, can easily accommodate a change of scale, to pass from a millimetric pipe or tube, or even larger ducts. In this way, an ultrafiltration device with microfiltration pores is obtained, therefore with potentially higher flow rates and less clogging. Simple calculations show that a plate five mm thick pierced with holes 7.5 μm in diameter and a square pitch of 20 μm would have a flow rate of less than 1 bar de 2500 L/hour·m², a much higher level of performance than the ultrafiltration membranes used in laboratories. Such devices should therefore find applications in the downstream purification/concentration processes in bioproduction (“DownStream Processes”).

The treatment systems that are the subjects of the present invention can supply concentration and purification systems, in particular at laboratory-scale, for example for purifying antibodies, nanoparticles, or nucleic acids where the operator operates at the order of a microgram of product.

It is noted that, in the method disclosed in FR 3 024 544, the single-channel device described includes a progressive restriction of the channel's cross-section, such that there can be a separation of the molecules or analytes to be concentrated along the cross-section restriction. But it is also possible to stop the molecules or particles of interest with simple straight channels. For this, the flow and electric field conditions are fixed such that the molecules, in the outlet channels of the concentration area, are pressed so close to the wall that the electrophoresis force is stronger than the flow drive. In this case, the molecules in the channel go back along the wall. If the flow has a Poiseuille profile to the channel intake, the molecules exit from the channel, and are concentrated upstream from the channels, in the concentration area with a larger cross-section. If the flow has disruptions in the Poiseuille profile at the channel intake, the molecules are concentrated in this area of disruption at the channel intake.

Utilizing the system concentrates the molecules or particles of large size and electrical charges, and lets the smaller or less charged molecules or particles pass. This characteristic is put to use to purify and concentrate a sample before analysis.

This in-line concentration technique adapts to any type of nano-objects or micro-objects, such as:
DNA fragments;
other macromolecules, such as proteins or carbohydrates;
complexes, which can include many small molecules, such as pollutants, steroids, etc;
nanoparticles, especially those used as a delivery vector for medicines by the pharmaceutical industry;
viral or bacterial particles.

It is noted that the plate with the plurality of channels can be produced by laser machining, DRIE (acronym for Deep Reactive Ion Etching) or another method of micro-precision machining, to obtain bores with a diameter of several microns to several tens of microns.

In some embodiments, the outlet channels are sized such that the average shear in these channels is strictly greater than the average shear present in the intake channel of said device.

Typically, the average shear ratio between the intake channel and each outlet channel of the concentration area must be less than 0.01.

In some embodiments, the system that is the subject of the present invention comprises a multicapillary having linear channels, the concentration area being on one side of this multicapillary. It is noted that a multicapillary is a capillary with several channels, or pathways. To insert it into the device, it can be cut and pasted between the intake channel and the exit duct.

These embodiments can be achieved, for example, by sleeving, gluing or soldering their components. In this way, costly machining is avoided and one can have channels or pathways of any desired length. Multicapillaries exist in the form of photonic crystal optical fibers. Multicapillaries can also be produced by assembling a bundle of individual capillaries and filling the interstices between capillaries using a resin.

In some embodiments, the concentration area comprises a plurality of cones formed in a diaphragm perpendicular to the central axis of flow of the fluid exiting from the concentration area.

By laser machining a silica plate, such an arrangement is obtained more easily with parallel cones rather than an arrangement with parallel cylinders.

In some embodiments, the electric field application means is configured to apply a progressive decrease in the electric field after the concentration phase, for separating the molecules concentrated beforehand.

According to a fourth aspect, the present invention relates to a kit for the operation of the system that is the subject of the present invention, that comprises the viscoelastic liquid.

According to a fifth aspect, the present invention relates to a kit for the operation of the system that is the subject of the present invention, that comprises the concentration, pre-concentration by sample stacking and/or purification device, said device comprising a concentration area having, in a direction of flow, a plurality of outlet channels.

In some embodiments of the kit that is the subject of the present invention, the channels of the plurality of outlet channels are sized such that the average shear in these channels is much greater (at least double) than the average shear present in the intake channel of said device.

These kits, which are the subjects of the present invention, can be combined into a single kit. It is noted that one or other of these kits that are the subjects of the present invention can also comprise:
other reagents, depending on the application envisaged, for example a control sample to check proper operation;
a molecular weight standard;
a mass standard; and/or
a loading buffer to be added to the sample.

As the particular features, advantages and aims of these kits are similar to those of the system that is the subject of the present invention, they are not repeated here.

### BRIEF DESCRIPTION OF THE FIGURES

Other advantages, aims and particular features of the invention will become apparent from the non-limiting description that follows of at least one particular embodiment of the devices and the method that are the subjects of the present invention, with reference to drawings included in an appendix, wherein:

FIGS. 1, 2 and 3 represent, schematically and in cross-section, particular embodiments of a concentration device for the system that is the subject of the present invention;

FIG. 4 represents, schematically and in cross-section, a particular embodiment of a concentration device for the system that is the subject of the present invention;

FIG. 5 represents a particular embodiment of the system that is the subject of the present invention;

FIGS. 6 and 7 represent, in an axial cross-section view and in a longitudinal view, respectively, a multicapillary;

FIG. 8 represents a variant of the device shown in FIG. 3;

FIG. 9 represents, schematically, a mono-capillary concentration device;

FIG. 10 represents, schematically, a multicapillary device, an embodiment of the invention;

FIG. 11 shows a photograph of the multicapillary concentration device shown schematically in FIG. 10;

FIG. 12 shows an image, made using a scanning electron microscope, of the multicapillary shown in FIGS. 10 and 11;

FIG. 13 shows a pair of photographs taken during the concentration, at the start and end of the concentration;

FIG. 14 represents curves plotting changes in fluorescence intensity during concentration;

FIG. 15 represents, schematically and in cross-section, a first particular embodiment of the system that is the subject of the present invention;

FIGS. 16A to 16E represent, in cross-section, a portion of the system shown in FIG. 15 during five operational phases of this system;

FIG. 17 represents coupling curves showing the electric field's influence on the speed of DNA fragments;

FIGS. 18A to 18E represent, in cross-section, a portion of one of the systems shown in FIGS. 15 to 16E, during a series of steps separating molecules or particles of interest;

FIGS. 19 to 22 represent, schematically and in cross-section, particular embodiments of a concentration device for the system that is the subject of the present invention;

FIG. 23 represents, schematically and in cross-section, a valve for the system that is the subject of the present invention;

FIG. 24 represents, in the form of a logical diagram, steps in a particular embodiment of a method that is the subject of the present invention; and

FIGS. 25 and 26 show, in the form of DNA migration graphs, the effects of utilizing the present invention.

### DESCRIPTION OF EXAMPLES OF REALIZATION OF THE INVENTION

It is now noted that the figures are not to scale.

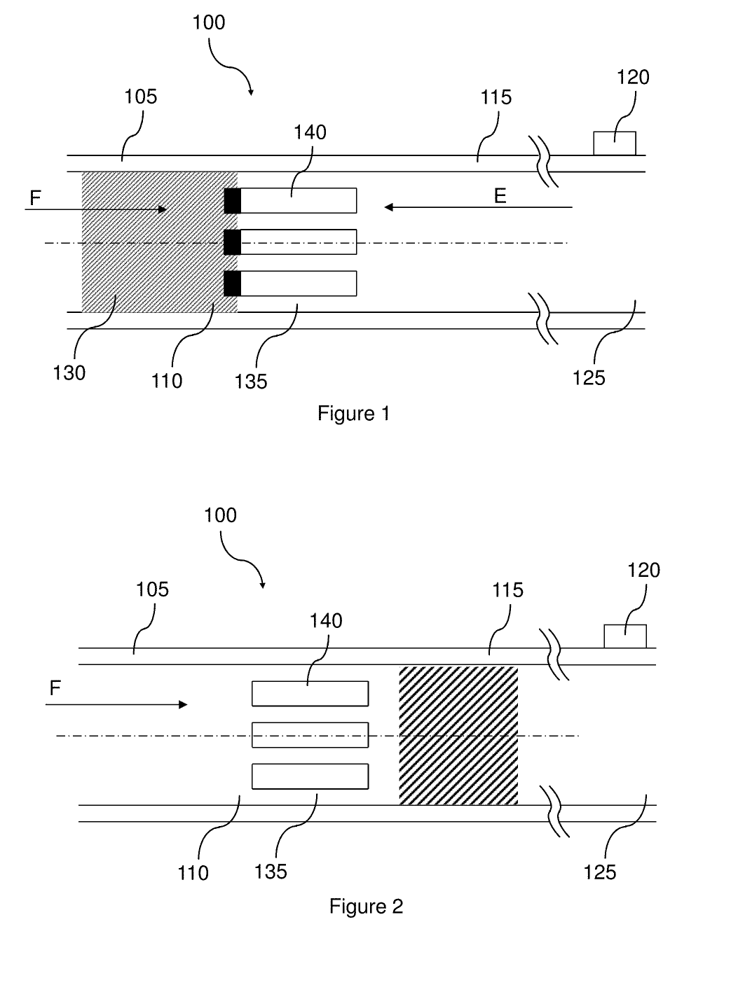

In the embodiments shown with reference to FIGS. 1 to 4 and 6 to 14, a plurality of channels is used in which a viscoelastic fluid flows by means of the application of a pressure difference between the two ends of the channels.

FIG. 1 shows a portion 100 of a first embodiment of the device for concentration, stacking and/or purification for analysis. This portion 100 comprises an intake channel 105, a concentration area 110 in the entrance to parallel outlet channels 135, and an exit duct 115.

As shown in FIG. 1, to utilize the first embodiment of the device, first a hydrodynamic or electrokinetic injection of a sample 130 is realized, using conventional methods in capillary electrophoresis or chromatography. It is noted, however, that because of the diameter of the intake channel 105, which can be large, a much larger volume can be injected here than in conventional capillary electrophoresis, for example between 0.01 and 10 ml for laboratory-scale sample preparation, even several liters at pilot- or industrial-scale. The intake channel 105, concentration area 110 and exit duct 115 are filled beforehand with viscoelastic fluid. Preferably, the sample 130 has also been diluted in this viscoelastic fluid.

As shown in FIG. 1, after the injection, the entrance to the intake channel 105 being connected to a bottle (not shown) containing the viscoelastic buffer or fluid, a pressure differential and an electrical voltage differential are applied between the entrance to the intake channel 105 and the outlet 125 of the exit duct 115. The action of the electric field E is opposite to the viscoelastic fluid flow F, the direction of the electric field E depending on the sign of the charge of the molecule/particle to be concentrated. As explained above, the particles or molecules of the sample 130 are concentrated in the concentration area 110 upstream from parallel channels, possibly with a separation according to size and electric charge along lines of iso-shear (ie equal shear).

Once the entire sample 130 has passed into the concentration area 110, the concentrated, and possibly separated, particles or molecules remain there. Scrubbing then takes place by passing an excess of viscoelastic fluid through. In this way, the molecules or particles not retained in the concentration area 110 are drawn out of the concentration device, via the exit duct 115, and therefore do not interfere with the subsequent detection of molecules or particles of interest. This also allows the molecules or particles of interest to be purified before they are collected downstream from the concentration device.

The concentrated molecules are then migrated solely by pressure, with a zero electric field, as shown in FIG. 2. The concentrate is transferred in this way from the concentration area to the exit duct 115.

It is noted that there is no stacking during this transfer: it is the concentration step, performing the stacking role, which makes the plug of concentrated molecules or particles exiting from the concentration area 110 have a volume that is not dependent on the initial volume of the sample.

Alternatively, the concentrated molecules can be migrated by electrophoresis. In this case, the flow is stopped and an electric field is applied drawing the molecules towards the outlet of the device 100.

In a first mode of use of the device, one wants to retrieve all the molecules or particles that have been concentrated. For this one just has to collect the sample downstream from the device, using the methods of the state of the art, for example by using a fraction collector or a suitable valve.

In a second mode of use of the device, one wants to retrieve only a portion of the molecules or particles that have been concentrated. For example, one wants to retrieve nucleic acids of a given size, by removing the fragments that are shorter or longer than this size. Or similarly for proteins, particles, cells, etc.

In this second mode of use, a separation phase is performed between the concentration phase and the collection phase.

The separation can take place solely by electrophoresis, in the exit duct 115. In this case, a neutral polymer is chosen to produce the viscoelastic liquid. such that the viscoelastic liquid also constitutes an electrophoresis matrix for separating the molecules or particles of interest.

The separation can also take place as described above and in patent application FR 2 994 103; in this embodiment, the outlet channels 135 of the concentration area 110 are extended beyond what is necessary solely for the concentration phase, and can in addition substitute for the exit duct 115. Pressure and voltage are then applied in opposite directions, and the particles or molecules separate along a distribution. They possibly pass in front of the optional detector 120, to be detected and analyzed there. Collecting the molecules or particles of interest therefore takes place on output from the multicapillary 135, possibly extended by an exit duct 115, by state of the art means, for example using a fraction collector or a suitable valve. The detector 120 can advantageously be used to control the function of collecting molecules or particles of interest, for example to control the start and end of the collection according to the migration times measured.

In some preferred embodiments, the separation is achieved by configuring the electric field application means to apply a progressive decrease in the electric field E after the concentration phase, for separating the molecules.

The separation therefore takes place by reducing, gradually or stepwise, the electric field E applied during the concentration. It is noted that, in effect, if, after the concentration phase, the intensity of the electric field E is gradually reduced, for example according to a decreasing linear function, this has the effect of making the molecules or particles of interest pass through the channels 135 defining the concentration area 110, and then the exit duct 115 and the detector 120 (if there is one), successively according to their sizes and electrical charges.

In this way one achieves an ordered separation of the molecules or particles of interest that pass in front of the optional detector 120, and which can be collected by the state of the art means.

It is noted that it is advantageous to place the detector 120 and the collection means as close as possible to the concentration area 110, to reduce as far as possible the effects of axial or Brownian diffusion or diffusion linked to the parabolic profile of the laminar flow, which could lead to molecules and particles of interest of different sizes and charges being mixed together again.

It is noted that, according to this invention, the separation between two detection peaks for molecules or particles can be adjusted, by modulating the speed at which the intensity of the electric field E is reduced. For example, steps can be made, which leads to the formation of ranges of sizes and charges of molecules passing in front of the detector 120 and being collected.

The invention has other advantages:
a long separation channel and exit duct 115 are not necessary; as a result, the dimensions of the device are reduced;
as the problem of possible pollution of the exit duct 115 by the unconcentrated impurities is proportional to the length of this exit duct 115, it is substantially resolved by the very small length of this exit duct 115.

It is noted that all these modes of use and embodiments of the device can be realized with a concentration area 110 comprising a plurality of cones (see FIG. 8) formed in a diaphragm perpendicular to the central axis of flow of the fluid exiting from the concentration area 110. The angle formed by the inlet walls of the channels with the common axis of the channels has an impact on the concentration. A large angle, giving a short cone, generates steep force gradients and a squat concentration area 110. In contrast, a small angle, corresponding to an elongated cone, generates more gradual force gradients and a larger concentration area 110.

One advantage of the embodiments in which the channels 135 have intake cones, in particular in relation to embodiments in which the channels 135 emerge perpendicular to the wall, is that the concentration device simultaneously brings about a certain level of separation among the concentrated molecules or particles. The smallest or least charged molecules or particles are located closest to the neck of the concentration area 110 cones. During the possible separation and detection step, they remain in front of the slower molecules or particles, and therefore do not need to overtake them.

Therefore, a much larger volume of sample 130 can be injected into the device than is possible in conventional capillary electrophoresis or with a concentration device formed from a single channel 135.

Another advantage is that the sample 130 undergoes purification: the molecules or particles with no charge or an opposite charge to the molecules or particles of interest are removed from the sample. The molecules or particles that have a charge of the same sign as the molecules or particles of interest, but which are too small or insufficiently charged, are also removed from the sample. In particular, the salts contained in the sample are removed during the concentration. This purification brings improvements in the quality of separation and level of purity of the molecules or particles after collection.

In the device 100 partially illustrated in FIGS. 1 and 2, a plate 140 having linear through holes, or openings, 135 separates two channels 105 and 115 with the same inner and outer cross-sections. This embodiment can be achieved, for example, by sleeving, gluing or soldering its components. This embodiment has the advantage of increasing the number of necks of the concentration area, which can make it possible to increase the concentration phenomenon and the volume of the sample treated. It is noted that the exit duct 115 can have a different inner cross-section from that of the intake channel 105.

It is noted that the plate 140 can be produced by conventional machining, laser machining, DRIE (acronym for Deep Reactive Ion Etching) or other method of micro-precision machining, to obtain bores with a diameter from several microns to several tens of microns. It is also noted that conical bores, known as “tapers” in laser machining, can be used.

It is also noted that it is more advantageous for manufacture to produce a plurality of parallel channels exiting from the concentration area 110. But the parallelism is not necessary for the proper operation of the system.

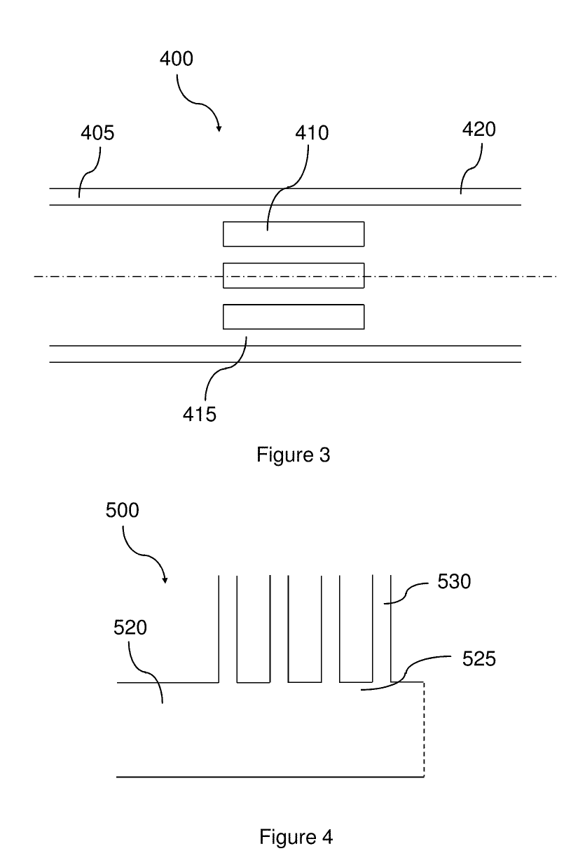

In the device 400 partially illustrated in FIG. 3, a multicapillary 410 having linear outlet channels 415 separates two channels 405 and 420 with the same inner and outer cross-sections. This embodiment can be achieved, for example, by sleeving, gluing or soldering its components. It is noted that the exit duct 420 can have a different inner cross-section from that of the intake channel 405.

It is noted that a multicapillary 410 is a capillary with several channels, or pathways. To insert it into the device, it is cut and pasted between the channels 405 and 420. Compared to the embodiment shown in FIGS. 1 and 2, costly machining is avoided and one can have channels or pathways of any desired length. Multicapillaries exist in the form of photonic crystal optical fibers, for example under the registered trademark NKT Photonics.

With respect to the devices with several capillaries mounted in parallel, such as those shown in FIGS. 1, 2 and 3, it is noted that cones can replace the cylindrical capillaries, with the effects explained above for the conical portion. In addition, by laser machining a silica plate, such an arrangement is obtained more easily with parallel cones rather than an arrangement with parallel cylinders.

The scheme shown in FIGS. 1, 2 and 3 can easily accommodate a change of scale, to pass from a millimetric pipe or tube, or even larger ducts. In this way, an ultrafiltration device with microfiltration pores is obtained, therefore with potentially higher flow rates and less clogging.

Simple calculations show that a plate five mm thick pierced with holes 7.5 μm in diameter and a square pitch of 20 μm would have a flow rate of less than 1 bar de 2500 L/hour·m², a much higher level of performance than the ultrafiltration membranes used in laboratories (for example, the Vivaflow system from Sartorius, or the Pellicon system from Millipore, registered trademarks).

Such devices should therefore find applications in the downstream purification/concentration processes in bioproduction (“DownStream Processes” in this community's vocabulary).

FIG. 4 shows an embodiment 500 of the concentration device, consisting of an intake channel 520 emerging at the outlet capillaries 530 of concentration parallel to each other and each forming an angle with the intake channel. The concentration area 525 is located where the channel 520 emerges at the capillaries 530 and/or in the intakes of the capillaries 530.

In the embodiment shown in FIG. 4, a minor, or at least partial, flow goes into the outlet capillaries 530, therefore the concentration is not 100%. However, by making the sample circulate in a closed circuit a concentration close to 100% can be obtained.

It is noted that the sum of the cross-sections of the parallel channels can be equal to or greater than the cross-section of the intake channel and/or of the exit duct. This is because the hydrodynamic resistance of the set of capillaries is much greater than the hydrodynamic resistance of a cylindrical channel with a cross-section equal to the sum of the cross-sections of the capillaries. An increase in the pressure gradient, and therefore of the shear, is obtained without reducing the cross-section.

The concentration, stacking or separation device described with reference to FIGS. 1, 2, 3 and 4 is used for analyzing macromolecules and nanoparticles for the life sciences, therefore in an aqueous solution, and for organic solutions and microparticles.

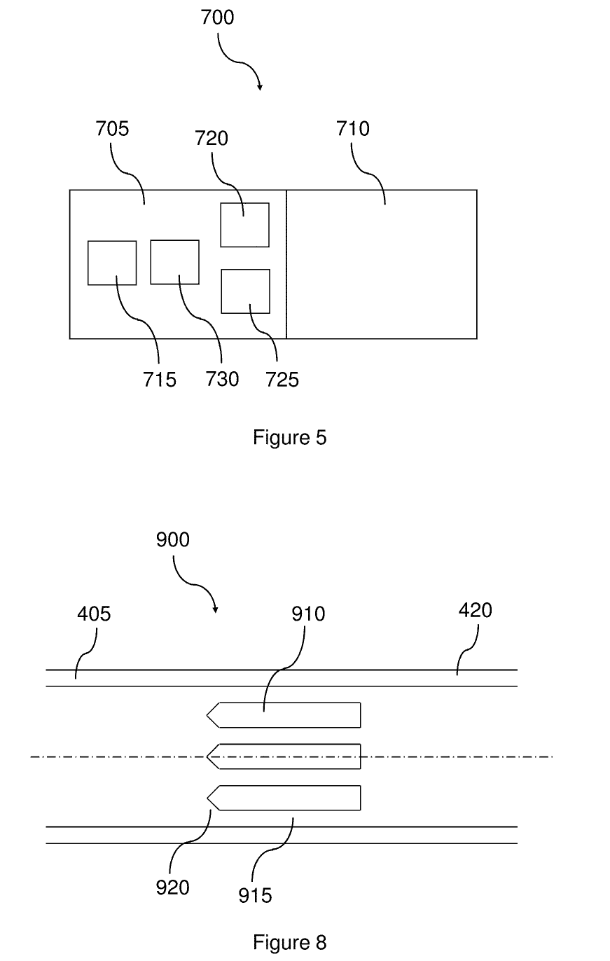

FIG. 5 shows a system 700 comprising a concentration, stacking and/or purification device 705 and an optional analysis preparation and/or analysis instrument 710.

The device 705 is any one of the devices described with reference to FIGS. 1 to 4. It comprises:
a means 715 for establishing a laminar flow, during at least one portion, referred to as “concentration phase”, of the operating time of the system, of the viscoelastic liquid in a concentration, stacking and/or purification device, said device comprising a concentration area 720 having, in the direction of said flow, a plurality of outlet channels sized such that the average shear in these channels is much greater, at least double, than the average shear present in the intake channel of said device;
a means 725 for applying an electric field between the intake and the outlet of the concentration area, the action of the electric field on the molecules or particles of interest being, in the concentration area, opposite to the direction of said flow and causing the molecules or particles of interest to be retained at least in the concentration area; and
a means 730 for transferring the concentrated sample from the concentration area 720 to the outlet.

As described above, after the concentration phase, the electric field has an intensity less than or equal to the electric field applied during the concentration phase, for example according to a linear decreasing slope or stepwise, or a zero intensity immediately after the end of the application of the concentration phase. It can also be in an opposite direction to that used for the concentration, and strong or weak depending on the characteristics of the electrophoresis that is then applied.

Among the types of optional analysis instruments 710, the following can be mentioned in particular:
capillary electrophoresis, in which case it is advantageous to use the electrical power supply of the capillary electrophoresis as the means 725 for applying the electric field, and the pressure generator of the capillary electrophoresis as the means 715 for establishing a capillary flow;
mass spectrometer;
gel filtration or size-exclusion chromatography;
spectrometers;
liquid chromatography in all its forms (LC, HPLC, UPLC, micro-LC, nano-LC);
a simple detector, for example optical (absorbance, fluorescence, refraction), conductometric, electrochemical, etc;
a fraction collector;
a system of valves making it possible to collect only the molecules or particles selected by the concentration and separation device.

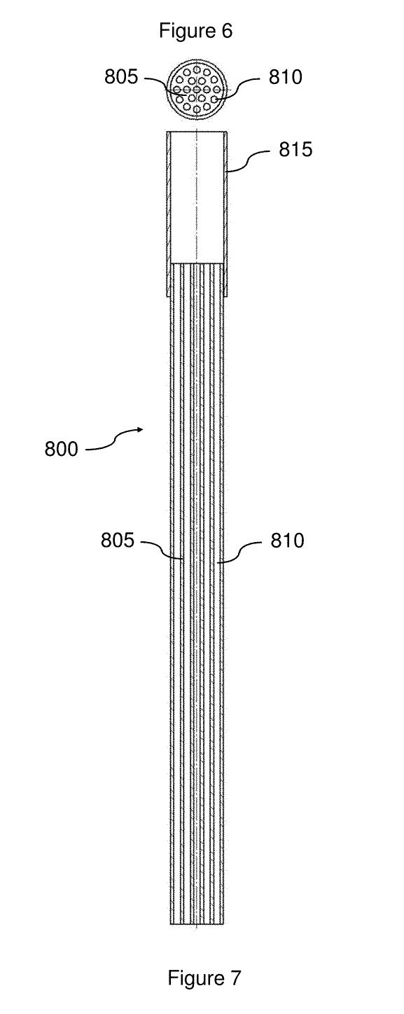

FIGS. 6 and 7 show a multicapillary 800 comprising, in a cylinder 805, parallel cylindrical channels 810. A sleeve 815 can be added to help assemble the multicapillary 800 to a means 715 for establishing a laminar flow of the liquid.

FIG. 8 shows a concentration device 900 comprising a multicapillary 910 having linear outlet channels 915, which separates two channels 405 and 420 with the same inner and outer cross-sections. The outlet channels 915 each comprise an intake cone 920. These cones 920 and the outlet channels 915 are, for example, formed in a diaphragm perpendicular to the central axis of flow of the fluid exiting from the concentration area.

An additional description is given below for the sizing of the concentration area outlet channels and, in particular, explanations of the sizing calculation.

The person skilled in the art knows how to size the number and cross-section of the channels such that the shear in the concentration area outlet channels is greater than the shear in the intake channel.

If all the channels are cylindrical, and for laminar flows of an incompressible liquid, an analytical solution to the problem is possible, as we show below (Poiseuille equations).

If the channels are flat channels, with a very small height in relation to their width, an analytical solution to the problem also exists (Poiseuille equations for flat flows).

Lastly, for other cross-section shapes of channels, the multiphysics modelling tools of the state of the art, such as the COMSOL system, make it possible to find the required sizing, by solving the Navier-Stokes equations by finite elements.

Consider the basic case, in which the intake channel to the concentration area is a cylindrical channel with a radius R₁, and the plurality of outlet channels from the concentration area consists of n identical cylindrical channels with a radius R₂.

Generally, in a laminar flow in a duct, the relationship is given by:

ΔP=Rh×Q Equation 1:

where ΔP is the pressure drop at the terminals of the duct, Rh is the hydraulic resistance of the duct, and Q is the flow rate.

For each unit of length of the duct:

$$\frac{dP}{dz} = \frac{dRh}{dz} \times Q , \qquad Equation 2$$

where dz is an infinitesimal unit of length.

The flow rate Q is identical in the intake channel and in the plurality of outlet channels. Therefore:

$$Q = \frac{\begin{matrix}{dP}_{1} \\ dz\end{matrix}}{\frac{{dRh}_{1}}{dz}} = \frac{\begin{matrix}{dP}_{2} \\ dz\end{matrix}}{\frac{{dRh}_{2}}{dz}} , \qquad Equation 3$$

where subscripts 1 and 2 refer respectively to intake channel and the plurality of outlet channels.

For a laminar flow of a Newtonian fluid in a cylindrical duct, then, according to the Poiseuille equations, which can be found, for example, in the corresponding Wikipedia article (https://fr.wikipedia.org/wiki/%C3%89coulement_de_Poiseuille):

$$v ( r ) = {v}_{max } ( 1 - \frac{{r}^{2}}{{R}^{2}} ) , \qquad Equation 4$$

where v(r) is the speed of the fluid at every point located at distance r from the axis of the duct, and vₘₐₓ□ is the maximum speed of the fluid, at the center of the duct.

vₘₐₓ□ is also simply expressed in analytical form by:

$${v}_{max } = \frac{{R}^{2}}{4 μ} \frac{dP}{dz} \qquad Equation 5$$

The shear constraint is defined by:

$$σ ( r ) = μ \frac{dv ( r )}{dr} , \qquad Equation 6$$

where μ is the dynamic viscosity of the fluid.

Deriving Equation 4, by applying

$$\frac{dv ( r )}{dr}$$

in Equation 6 and also applying the expression vₘₐₓ□ from Equation 5, gives:

$$σ ( r ) = \frac{r}{2} \frac{dP}{dz} \qquad Equation 7$$

At mid-radius of the duct, the average shear is therefore:

$${σ}_{moy} = \frac{R}{4} \frac{dP}{dz} \qquad Equation 8$$

This gives the value of

$$\frac{dP}{dz} ,$$

which can be applied in Equation 3.

In the same way, the Poiseuille equations give the value of Rₕ:

$${R}_{h} = \frac{8 μ L}{π {R}^{4}} , \qquad Equation 9$$

where L is the length of the duct. Therefore, for each unit of length:

$$\frac{{dR}_{k}}{dz} = \frac{8 μ}{π {R}^{4}} \qquad Equation 10$$

This gives us, by applying Equation 8 and Equation 10 in Equation 3:

$$Q = \frac{4 {σ}_{moy , 1}}{{R}_{1}} \times \frac{π {R}_{1}^{4}}{8 μ} = \frac{π {σ}_{moy , 1} {R}_{1}^{3}}{2 μ} \qquad Equation 11$$

Since the n outlet channels are identical, this gives Q=n q₂, where q₂ is the flow rate in each of the outlet channels.

The above equations apply for each outlet channel, and Equation 11 becomes:

$$Q = \frac{π {σ}_{moy , 1} {R}_{1}^{3}}{2 μ} = n \frac{π {σ}_{moy , 2} {R}_{2}^{3}}{2 μ} \qquad Equation 12$$

One deduces from this that the ratio of the average shear in the system is:

$$\frac{ {σ}_{moy , 2} }{{σ}_{moy , 1}} = \frac{1}{n} \times {( \frac{{R}_{1}}{{R}_{2}} )}^{2} \qquad Equation 13$$

Therefore, if one designs a device having an intake channel with a radius of 1.5 mm, and 1,000 outlet channels with a radius of 25 μm, one obtains an average shear ratio of (Equation 13):

$$\frac{ {σ}_{moy , 2} }{{σ}_{moy , 1}} = \frac{1}{1000} \times {( \frac{1500}{25} )}^{3} = 216.$$

It is noted that it is easier to obtain high shear in the outlet channels if the sum of the cross-sections of the channels is much less than the cross-section of the intake channel.

However, if the number of outlet channels is at least equal to 10,000, a shear ratio greater than or equal to 100 can be obtained, even though the sum of the cross-sections of the outlet channels is equal to the cross-section of the intake channel. The possibility of this rises as the number of outlet channels increases.

Therefore, if one designs a device having an intake channel with a radius of 1.5 mm, and 10,000 outlet channels with a radius of 15 μm, one obtains an average shear ratio of (Equation 13):

$$\frac{ {σ}_{moy , 2} }{{σ}_{moy , 1}} = \frac{1}{10000} \times {( \frac{1500}{15} )}^{3} = 100 ,$$

even though the cross-section of the intake channel and the total cross-section of the outlet channels are both equal to 7.07 mm².

Lastly, it should be noted that the Poiseuille equations used above are true for a Newtonian liquid, whereas utilization of the present invention requires a viscoelastic liquid. This is because the Poiseuille equations are true when the viscosity μ is independent of the shear. The viscosity of a fluid is a characteristic separate from its elastic properties, and there are polymers that make the fluid viscoelastic, while the viscosity remains constant over a broad range of shear. Thus, the article by Del Giudice et al., 2015, Lab Chip 15, 783-792 shows that aqueous solutions containing up to 0.3% polyethylene oxide (PEO), or up to 0.1% polyacrylamide (PAM), have a constant viscosity for shear rates ranging from 0 (fluid at rest) to 200 s⁻¹, shear values that are sufficient for the system that is the subject of the present invention to work. The same is true for 8% polyvinylpyrrolidone (PVP) solutions, according to Romeo et al., 2013, 13, 2802-2807.

Should the developer of a device not have a viscoelastic fluid allowing the molecules or particles of interest to be collected under conditions where the viscosity of the fluid is constant, the developer uses a multiphysics simulation as mentioned earlier, using the most general form of the Navier-Stokes equations, which comprises a viscous constraints tensor, and determining the parameters of this tensor experimentally.

The ratio of the shear forces to be utilized between the intake channel and the outlet channels of the concentration area depends on the application envisaged, and on the time given for the desired concentration.

If the sample to be concentrated consists of strictly identical molecules or particles, the shear ratio does not necessarily have to be high; it is sufficient to adjust the flow speed and electric field such that the molecule to be concentrated advances with the flow in the intake channel, and is moved back by electrophoresis along the walls in the outlet channels, as explained above.

However, if the shear ratio is low, the molecules to be concentrated are pressed sufficiently strongly towards the walls in the intake channel, and they only advance slowly in this channel, limiting the concentration speed. To go faster, it is advantageous to increase the shear ratio in the intake channel flow, such that the molecules are not pressed towards the walls very strongly, and therefore not slowed down much. In practice, it is advantageous to have a shear ratio of at least 2, and preferably at least 10, between the intake channel and the outlet channels.

If, now, the sample to be concentrated consists of a heterogeneous population of molecules or particles, which therefore experience a force pressing them to the wall that differs according to their size and their charge, the shear needs to be adjusted such that the smallest or least charged molecules, which are the hardest to stop in the flow, are moved back by electrophoresis in the outlet channels, while the largest and/or most-charged molecules, which experience the greatest pressure towards to wall, advance sufficiently fast in the intake channel. In these cases, the shear ratio to be utilized is therefore dependent on the heterogeneity of the molecules to be concentrated. For DNA fragments of 0.1 to 1.5 kb, or 0.5 to 50 kb, a shear ratio greater than 100 is preferably used.

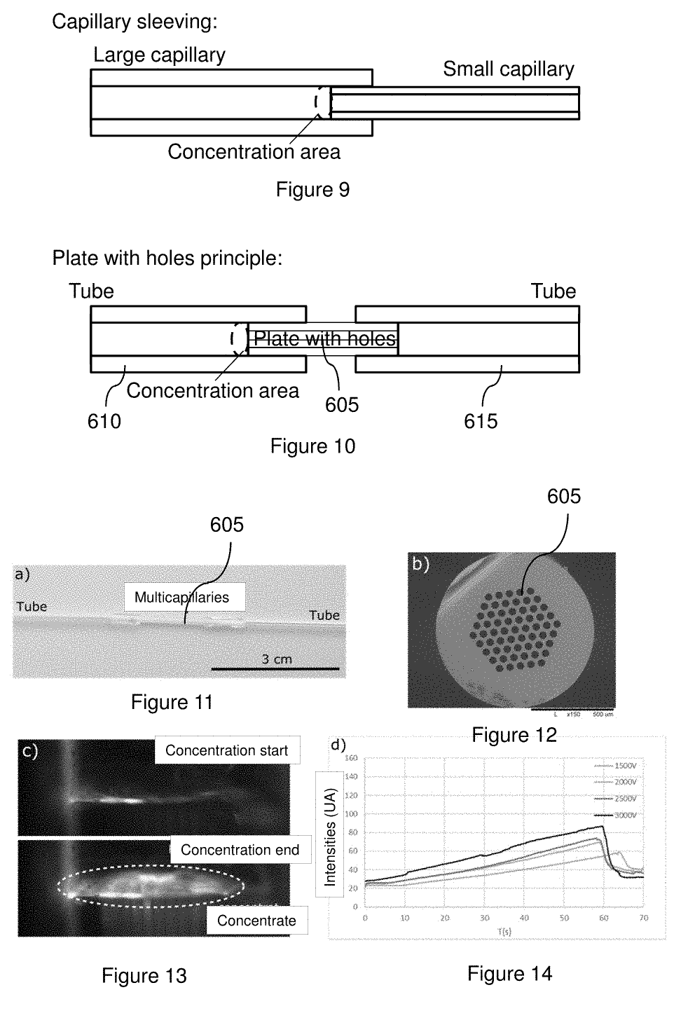

An experimental demonstration of a DNA concentration using a section of multicapillaries is given with reference to FIGS. 9 to 14. FIG. 9 shows a diagram of a mono-capillary concentration device. FIG. 10 shows a diagram of a multicapillary device consistent with aspects of the invention. These schematic diagrams show the concentration of the DNA in a simple system (capillary sleeving, FIG. 9) and in the case of a multicapillary system.

The multicapillary device in FIG. 10 was produced by sleeving a 3 cm-long multicapillary 605 having 61 capillaries with a diameter of 40 μm in two 60 cm-long hematocrit tubes 610 and 615 with an inner diameter of 1.1 mm (FIGS. 11 and 12), located on either side of the multicapillary.

A solution, consisting of 1×TBE+1% PVP360, and containing the DNA sample (kb Extended ladder at 0.1 μg/mL, YoYo-labeled; New England Biolabs, reference N3239S), is continuously injected into the device shown in FIG. 10, from left to right according to the diagram in FIG. 10. Pressure of between 50 and 150 mBar is applied, which generates flow rates between 10 and 30 μL/min (v=2.2-6.7 mm/s in the multicapillary 605).

To concentrate the sample, a voltage is applied to the terminals of the device, thus allowing an electric field to be created in the multicapillary 605 of between 45 and 270 V/cm an electric field exerting on the DNA a force opposite to the hydrodynamic flow.

The electric field is applied for one minute at a constant pressure. The DNA is therefore mostly concentrated at the intake of the channels of the multicapillary 605. Then the pressure is cut, while the electric field is still applied. The DNA therefore migrates by electrophoresis from the right to the left, and the concentrate is observed in the hematocrit tube at the start of this electrophoresis (FIG. 13).

Under these experimental conditions, volumes of between 10 and 30 μl were treated. During the concentration step, we observed an increase in the intensity of fluorescence at the junction between the multicapillary and the hematocrit tube (FIG. 14).

These initial results therefore meant we could demonstrate the feasibility of concentrating DNA using a multicapillary with a flow rate of 10 to 30 μI/min, a much higher flow rate than can be achieved with a mono-capillary device.

FIG. 11: Photograph of the multicapillary concentration device; FIG. 12: scanning electron microscope image of the multicapillary 605 that was used to produce the device;

FIG. 13: Photographs taken during the concentration, the top photograph taken at the start of concentration, the bottom one at the end of concentration; FIG. 14: Changes in the intensity of fluorescence during the concentration for a pressure of 100mBar and different voltages. The end of the concentration occurred at a time of approximately 60 seconds.

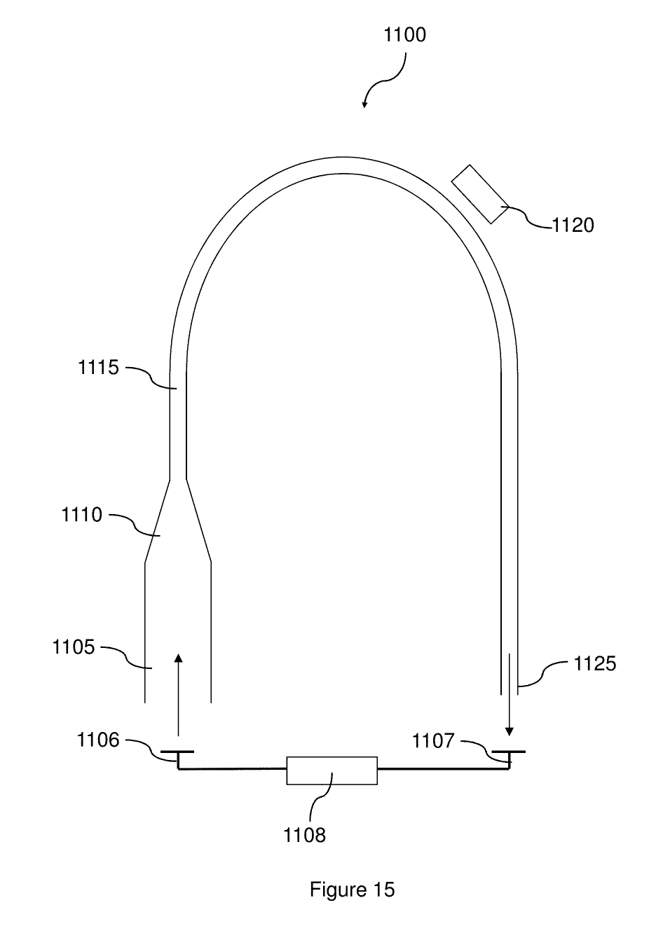

FIG. 15 shows a portion 1100 of an embodiment of the device for concentration, stacking and/or purification for analysis that is the subject of the present invention. This portion 1100 comprises an injection capillary 1105, for example 250 μm in diameter, a concentration area 1110, a separation capillary 1115, for example between 50 μm and 75 μm in diameter, an optional detector 1120, and an outlet 1125.

The concentration area 1110 can be conical, straight or comprise a plurality of channels. Electrodes 1106 and 1107, set to different electrical potentials, generate an electric field in all of the fluid present in the portion 1100. A means 1108 for modulating this electric field varies, in accordance with the present invention, the difference in potential between the electrodes 1106 and 1107, as described below.

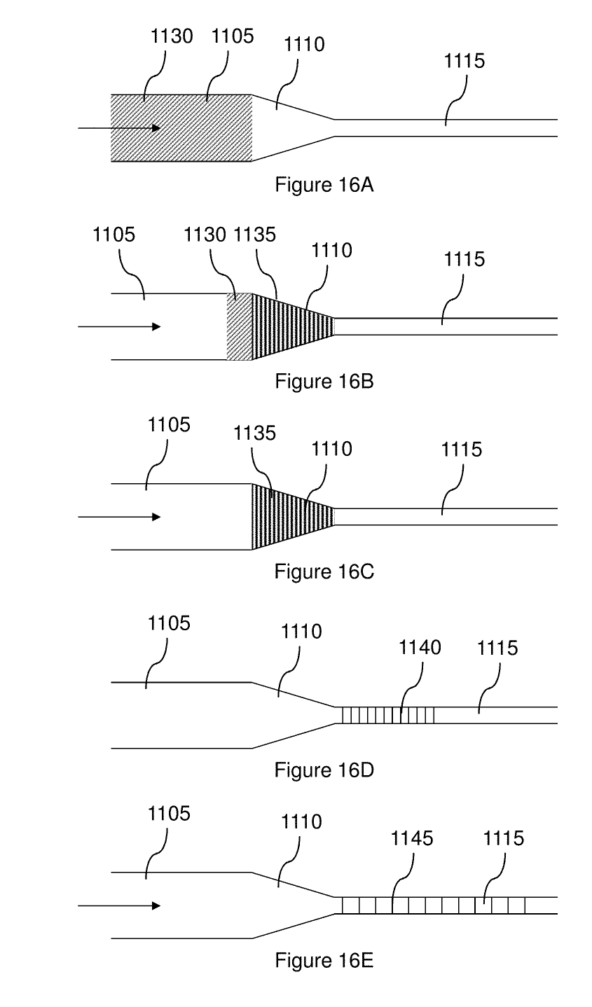

As shown in FIG. 16A, to utilize the embodiment of the device shown in FIG. 15, first a hydrodynamic or electrokinetic injection of a sample 1130 is realized, using conventional methods in capillary electrophoresis. It is noted, however, that, because of the diameter of the injection capillary 1105, a much larger volume can be injected here than in conventional capillary electrophoresis, for example between 0.1 and 10 μl. The injection capillary 1105, concentration area 1110 and separation capillary 1115 are filled beforehand with viscoelastic fluid. Preferably, the sample 1130 has also been diluted in this viscoelastic fluid.

As shown in FIG. 16B, after the injection, the entrance to the injection capillary 1105 is placed in the bottle containing the viscoelastic buffer or fluid, and a pressure differential and an electrical voltage differential are applied between the entrance to the injection capillary 1105 and the outlet 1125 of the separation capillary 1115. The action of the electric field is opposite to the flow of the viscoelastic buffer, the direction of the electric field depending on the sign of the charge of the molecule/particle to be concentrated. As explained above, the particles or molecules 1135 of the sample 1130 are concentrated in the concentration area 1110 with a separation according to size and electric charge along lines of iso-shear (ie equal shear).

As shown in FIG. 16C, once the entire sample 1130 has passed into the concentration area 1110, the concentrated and separated particles or molecules 1135 remain there. Scrubbing then takes place by passing an excess of viscoelastic fluid through. In this way, the molecules or particles not retained in the concentration area 1110 are drawn out of the separation capillary 1115, and therefore do not interfere with the detection. The particles or molecules 1135 are thus purified.

As shown in FIG. 16D, the concentrate intended for the separation 1140, subsequently called “plug”, is then put in place. To this end, pressure and electrical voltage differentials are removed. Then the concentrated molecules or particles are migrated solely by electrophoresis from the end of the concentration area 1110 to the start of the separation capillary 1115. The length of this separation plug is not dependent on the initial volume of the injection plug. In another embodiment of the exit after concentration, the concentrated molecules are migrated solely by pressure, with a zero electric field. The concentrate is transferred from the concentration area to the start area for the analysis (“injection plug”) or simply for the collection of the concentrated and purified molecules.

It is noted that there is no stacking during this exit: it is the concentration step, performing the stacking role, which makes the separation plug have a volume that is not dependent on the initial volume of the sample.

As shown in FIG. 16E, one then possibly performs an additional separation, by modulating the electric field applied, and the detection. The separation can take place either solely by electrophoresis, or by separation as described in patent application FR 2 994 103, by applying pressure and voltage in opposite directions.

In the embodiments comprising a detector 1120, when the particles or molecules 1135, separated along the distribution 1145 thus obtained, pass in front of the detector 1120, they are detected there and analyzed.

It is noted that the angle formed by the walls of the concentration area 1110 with the central axis common to the capillaries 1105 and 1115 has an impact on the concentration. A large angle, giving a short cone, generates steep force gradients and a squat concentration area 1110. In contrast, a small angle, corresponding to an elongated cone, generates more gradual force gradients and a larger concentration area 1110.

One advantage of this embodiment is that the quicker molecules or particles are located closest to the neck of the concentration area 1110. During the separation and detection step (FIG. 16E), they remain in front of the slower molecules or particles, and therefore do not need to overtake them.

Thanks to the utilization of the present invention, a much larger volume of sample 1130 can be injected into the device than possible in conventional capillary electrophoresis. This is because, in conventional capillary electrophoresis, a reasonable size of the injection plug must be preserved, otherwise analysis resolution must be lost.

Another advantage of the utilization of the present invention is that the sample 1130 undergoes purification; the molecules or particles with no charge or an opposite charge to the molecules or particles of interest are removed from the sample. The molecules or particles that have a charge of the same sign as the molecules or particles of interest, but which are too small or insufficiently charged, are also removed from the sample. In particular, the salts contained in the sample are removed during the concentration. This purification increases the separation quality.

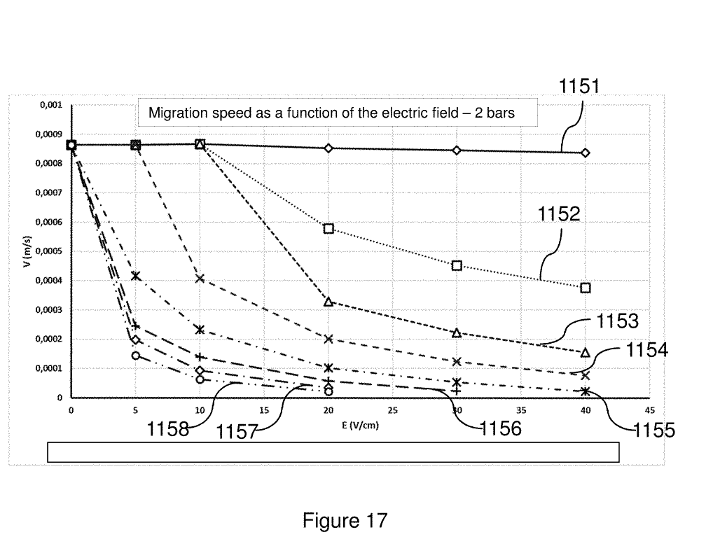

FIG. 17 shows, for a single capillary, without concentration, having a fixed detector, located 12 cm from the inlet, coupling curves showing the influence of the electric field on the DNA fragments' speed. A mixture of different sizes is introduced at the inlet, then pressure and electric field are applied in opposition.

Curves 1151 to 1158 correspond to DNA fragments, respectively of size 0.5 kb, 1 kb, 1.5 kb, 2 kb, 3 kb, 5 kb, 10 kb and 48.5 kb.

Curves 1151 to 1158 are obtained in a TBE+1% PVP buffer. Capillary 25 μm diameter, 1 m long. LIF detector 12 cm from the inlet. Pressure: 2 bars. The voltage applied varies from 0 to 4 kV (electric field from 0 to 40 V/cm).

For a given electric field (on the x-axis), it is seen that the DNA fragments have a different speed according to their size. The detector therefore sees them pass at different times: there is separation.

These curves can be extrapolated to determine when they cut the x-axis at a value defining a stop point and therefore deduce from this the concentration conditions for a given fluidic speed.

It can be seen that the stop electric field depends on the size of the DNA fragments. Therefore, for certain fields, the smallest fragments (1 kb) will not be stopped, whereas the largest fragments are stopped (or moved backwards). The fluidic speed at which these curves are acquired can be the speed at the neck of the concentrator. Thus, it can be seen that, as a function of the electric field, some fragments pass the neck and others do not.

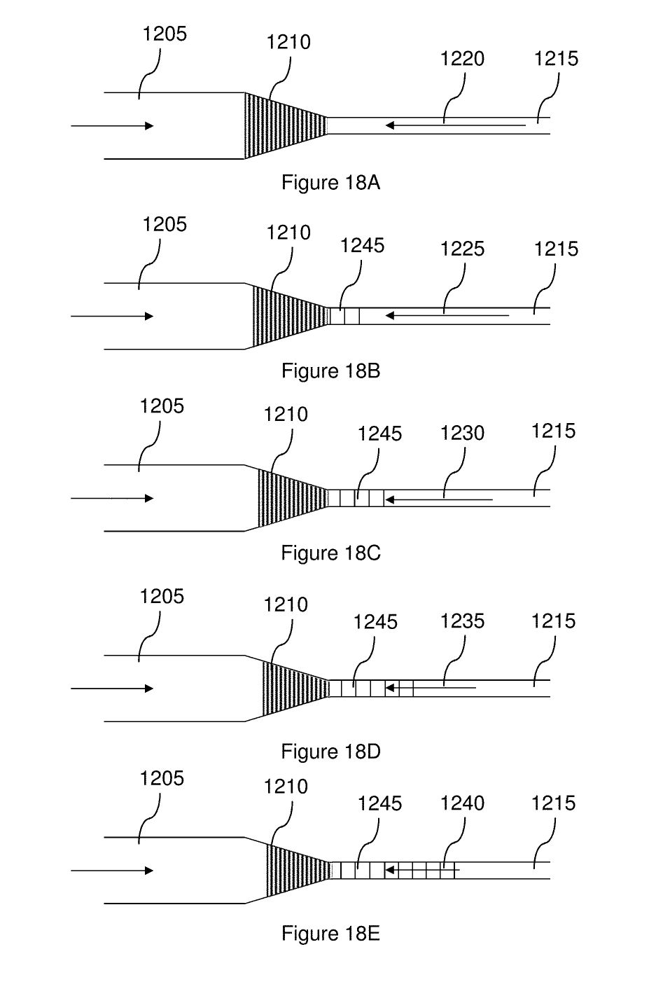

FIGS. 18A to 18E represent an enhancement of the concentration device, for increasing the separation of the particles and molecules retained in the concentration area, with a view to their analysis.

These FIGS. 18A to 18E show an injection capillary 1205, a concentration area 1210, and a separation capillary 1215. The electric field applied has been represented by arrows 1220 to 1240, respectively in FIGS. 18A to 18E. The length of these arrows is representative of the intensity of the electric field applied.

As shown in FIG. 18A, at the end of the scrubbing step, the molecules and particles of interest are retained in the concentration area 1210, and positioned at a distance from the junction neck between this concentration area 1210 and the separation capillary 1215, which is a function of their sizes and electrical charges and of the intensity of the electric field 1220.

Then, the electric field applied is reduced, for example by 10%, as shown by the arrow 1225 in FIG. 18B. The molecules and particles of interest closest to the neck therefore cross this neck and enter into the capillary separation 1215 while the other molecules and particles of interest remain in the concentration area 1210. If the electric field 1225 is maintained, the particles that have already entered the separation capillary 1215 are drawn by the viscoelastic fluid in a laminar movement and reach the detector placed downstream from the neck.

Here, as shown in FIGS. 18C to 18E, one continues to reduce the intensity of the electric field, for example according to a decreasing linear function. This has the effect of making the molecules or particles of interest pass into the neck successively, as a function of their sizes and electrical charges.

In this way an ordered separation of the molecules or particles of interest to be transferred is achieved.

It is noted that, in the embodiments comprising a detector, it is advantageous to place this detector as close as possible to the neck, to reduce as far as possible the effects of axial or Brownian diffusion or diffusion linked to the parabolic profile of the laminar flow, which could lead to molecules and particles of interest of different sizes and charges being mixed together again.

It is noted that, according to the enhancement described with reference to FIGS. 18A to 18E, the separation between two detection peaks for molecules or particles can be adjusted, by modulating the speed at which the intensity of the electric field is reduced. For example, steps can be made, which leads to the formation of ranges of sizes and charges of molecules passing in front of the detector. This mode of operation by steps is especially suitable for preparing DNA fractions by size groups, or fractions of other analytes according to their types, sizes or charges. This mode of operation by steps is shown in FIGS. 36 and 37 described below.

This enhancement has other advantages:
a long separation capillary is no longer necessary; the dimensions of the device that is the subject of the present invention are therefore reduced;
as the pollution problem mentioned earlier is proportional to the length of the separation capillary, it is substantially resolved by the very small length of this capillary.

Therefore, preferably, the system that is the subject of the present invention comprises a modulation means configured to control the means for applying the electric field in order to apply, after the concentration phase, an electric field of intensity other than zero and lower than the intensity of the electric field applied during the concentration phase.

Optionally, after the concentration phase, the speed of the viscoelastic fluid is also modified to produce the exiting of the concentrated sample.

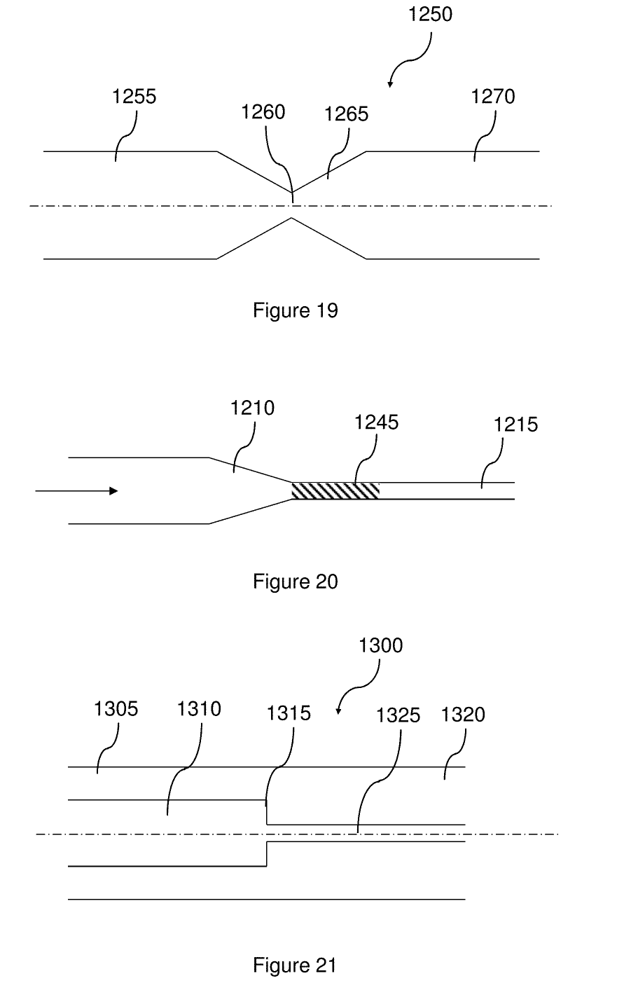

In some embodiments, microfluidic chips are used, whose section height is fixed and low, for example 10 μm. To produce the tapered edge of the concentration area, the width of the channel is reduced, without changing its height. These embodiments have the advantage that the molecules to be retained have a very short way to travel to reach their stop position near the wall. In this way, greater differences in width can be realized. For example, devices 1250 can be produced as represented in FIG. 19 in which the width of the injection capillary 1255 is between 300 and 1000 μm, in particular 600 μm, and the width of the neck 1260 is 10 to 20 μm, and the angle formed between the side walls of the concentration area and the central axis of the channel is 10° to 45°. In FIG. 19, the concentration area is followed by a symmetrical area 1265, the separation capillary 1270 having the same width as the injection capillary 1255.

In the embodiments based on cylindrical capillaries with a circular cross-section, only molecules or particles of interest carried by the flow and far from the walls at the entrance to the concentration area cross the concentration area without having the time to reach their stop position close to the wall. The particles or molecules therefore cross the neck and arrive in the separation capillary, where they meet flow, shear and electrical voltage conditions that make them move backwards towards the neck. If the device is designed and produced such that a Poiseuille profile, which describes the laminar flow of a viscous liquid in a cylindrical duct, is maintained throughout the transition between the concentration area and the separation capillary, the molecules or particles of interest that have crossed the neck move backwards, crossing the neck again, in the opposite direction, and finding their position of balance in the concentration area.

However, in a geometry with breaks, bulges or other imperfections, the laminar flow is disturbed and the Poiseuille parabolic profile is not present at the entrance to the separation capillary 1215. In this case, a portion 1245 of the molecules and particles of interest cannot return into the concentration area 1210 and they remain concentrated in the entrance to the separation capillary 1215, as shown in FIG. 20.

In these cases, at least one portion of the concentration of molecules or particles of interest is located downstream from the neck separating the restriction area from the separation capillary.

The modulation means, or electrical valve, of the device of the present invention also operates in these cases where concentration occurs downstream from the neck or necks of the concentrator (“inertial” concentrator).

FIG. 21 represents an embodiment variant of the devices shown in FIGS. 15 and 20.

In the device 1300 partially illustrated in FIG. 21, the concentration area 1315 forms a 90° angle with the central axis of the capillaries of injection 1305 and separation 1320. These capillaries have the same outer diameters but channels 1310 and 1325 with different inner diameters. This change of inner diameter forms a diaphragm perpendicular to the central axis of the flow of the viscoelastic fluid. The advantage of this embodiment is that it can be achieved by gluing two capillaries with the same outer cross-section, and also by sleeving.

It is noted that, in this type of configuration with a right angle, the concentration volume is greater than in the configurations with a tapered or conical portion. In this way, the capacity of the system is increased and thus the effects linked to adsorption to the walls is reduced. On the other hand, the concentrated molecules or particles are not separated according to their type, size or charge during the concentration phase.

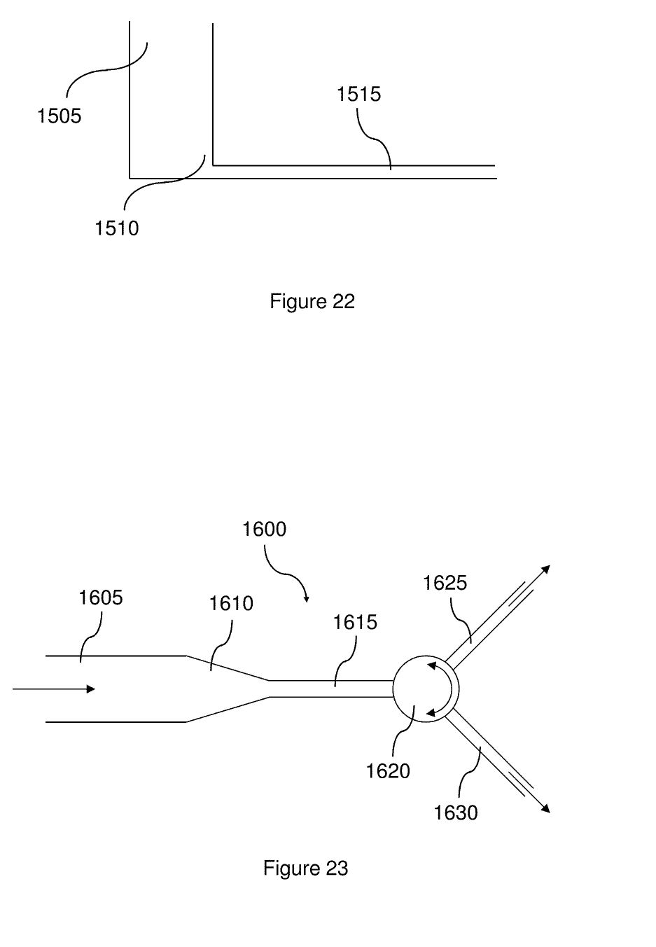

FIG. 22 shows an embodiment formed from the reunion of two capillaries 1505 and 1515, the intersection 1510 of these capillaries forming an angle, here a right angle. The concentration area for molecules or particles of interest is located at this intersection 1510. It is noted that the capillary 1505 can be replaced by a tank, or directly constitute the sample tank.

The concentration, stacking or separation device described with reference to FIGS. 15 to 22 operates for the capillary electrophoresis, the analysis of macromolecules and nanoparticles for the life sciences, therefore in an aqueous solution, and for organic solutions and microparticles.

FIG. 23 shows an enhancement applicable to all embodiments. This enhancement consists of positioning a valve 1620 between, firstly, a device 1600 comprising an injection capillary 1605, a concentration area 1610 and a separation or outlet capillary 1615 and, secondly, a rejection capillary 1625 or an intake capillary 1630 of an analysis instrument or an analysis preparation instrument, or simply a collection container. The valve 1620 is, for example, an HPLC (High-Performance Liquid Chromatography) type of rotary valve.

During the concentration and scrubbing steps, the rotary valve 1620 evacuates the viscoelastic fluid and the molecules and particles not retained in the concentration area towards the rejection capillary. In contrast, for the analysis or collection, the rotary valve 1620 orients the viscoelastic fluid and the molecules or particles of interest towards the detector or instrument.

When the device is used for a preparatory purpose at laboratory-scale, it is coupled to a fraction collector, as used traditionally in chromatography techniques.

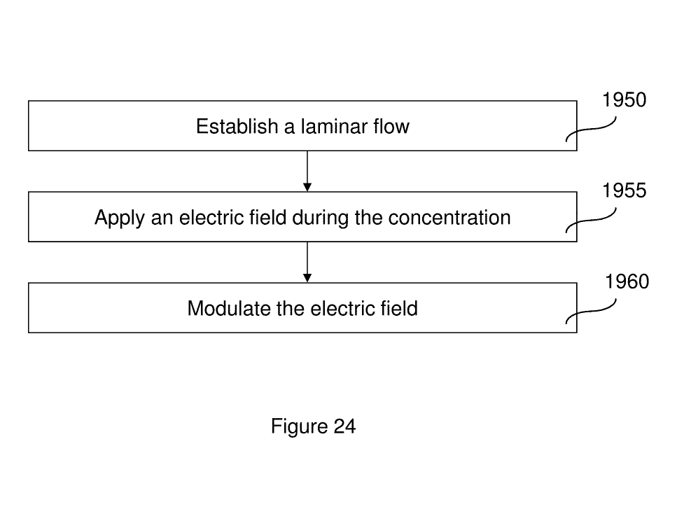

As shown in FIG. 24, the method for treating molecules or particles of interest carried by a viscoelastic liquid comprises:

a step 1950 of establishing a laminar flow, during at least one portion, referred to as “concentration phase”, of the viscoelastic liquid in a concentration, stacking and/or purification device, said device comprising a concentration area having, in the direction of said flow, an intake cross-section surface that is larger than the cross-section surface of each outlet channel;

at least during the concentration phase, a step 1955 of applying an electric field between the intake and the outlet of the concentration area, the action of the electric field on the molecules or particles of interest being, in the concentration area, opposite to the direction of said flow and causing the molecules or particles of interest to be retained at least in the concentration area;

a step 1960 of modulating the electric field in order to apply, after the concentration phase, an electric field with intensity other than zero and lower than the intensity of the electric field applied during the concentration phase.

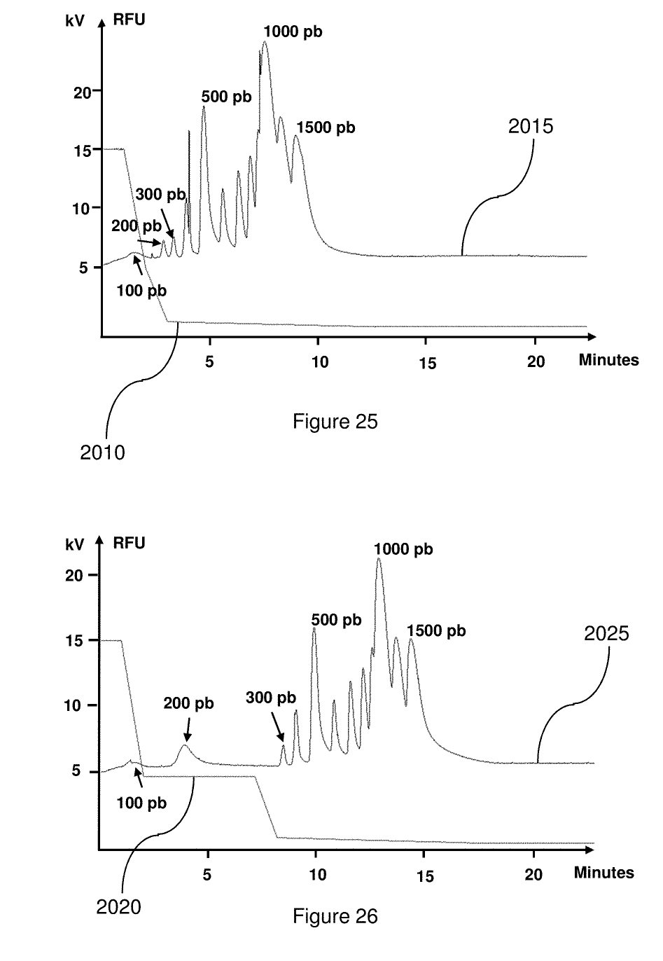

FIGS. 25 and 26 show the electrical valve effect obtained by utilizing the present invention. In the assembly used, a 5 kV step makes it possible to allow anything below 300 pb to pass and to retain 300 pb and anything higher than 300 pb.

### Method:

0.5×TBE+5% PVP buffer
Scrubbing: 6 bars, 15 min buffer
Injection: 4 bars, 1.7 min (100 bp ladder, 100 ng/mL)
Concentration: 2 bars, 15 kV during 5 min

FIG. 25: Separation by applying the voltage gradient 2010

At T0, the pressure is increased to 7 bars, leaving the voltage at 15 kV for 1 minute, voltage used during the concentration phase.
From t=1 minute to t=2 minutes, the voltage applied decreases rapidly and linearly from 15 kV to 5 kV.
From t=2 minutes to t=3 minutes, the voltage applied decreases more slowly and linearly from 5 kV to 0.5 kV.
From t=3 minutes to t=12 minutes, the voltage applied decreases even more slowly, from 0.5 kV to 0.2 kV.
For t>12 minutes, constant voltage of 0.2 kV.

By applying this voltage gradient 2010, the electropherogram 2015 is obtained.

FIG. 26: Separation by applying the electric field gradient 2020, which is identical to that applied to obtain the curve in FIG. 25, except that a 5 kV step 2020 is added from minute 2 to minute 7. By applying this voltage gradient 2020, the electropherogram 2025 is obtained.

Comparing FIGS. 25 and 26, it is clear that:
the 100 pb peak, which appears before minute 2, is not affected by this difference;
the 200 pb peak is delayed, and appears during the 5 kV step; and
the 300 pb and higher peaks are delayed exactly by the time of the step. They remain in the concentrator during the first 7 minutes.

The present invention also relates to a kit for utilizing the system that is the subject of the present invention, or for the operation of the system that is the subject of the present invention, which comprises the viscoelastic liquid.

The present invention also relates to a kit for utilizing the system that is the subject of the present invention, or for the operation of the system that is the subject of the present invention, which comprises the concentration, stacking and/or purification device, said device comprising a concentration area having, in a direction of flow, at least one outlet channel, each channel being preferably sized such that the average shear in this channel is much greater, at least double, than the average shear present in the intake channel of said device.

These kits, which are the subjects of the present invention, can be combined into a single kit. It is noted that one or other of these kits that are the subjects of the present invention can also comprise:
other reagents, depending on the application envisaged, for example a control sample to check proper operation;
a molecular weight standard;
a mass standard;
a loading buffer to be added to the sample.

1. System for treating molecules or particles of interest carried by a viscoelastic liquid, that comprises:
a means for establishing a laminar flow, during at least one portion, referred to as “concentration phase”, of the operating time of the system, of the viscoelastic liquid in a concentration, stacking and/or purification device, said device comprising a concentration area having, in the direction of said flow, an intake cross-section surface that is larger than the cross-section surface of each outlet channel;
a means for applying an electric field between the intake and the outlet of the concentration area during the concentration phase, the action of the electric field on the molecules or particles of interest being, in the concentration area, opposite to the direction of said flow and causing the molecules or particles of interest to be retained at least in the concentration area; and
a modulator that controls the means for applying the electric field in order to apply, after the concentration phase, an electric field with intensity other than zero and lower than the intensity of the electric field applied during the concentration phase.

2. System according to claim 1, wherein the concentration area comprises an intake channel and at least one outlet channel, the average shear present in each outlet channel being at least twice that of the average shear present in the intake channel.

3. System according to claim 1, wherein the modulation means is configured to control the electric field application means to apply an electric field decreasing over time.

4. System according to claim 1, that also comprises a pressure modulation means configured to apply, after the concentration phase, a different pressure than the pressure applied during the concentration phase.

5. System according to claim 4, wherein the pressure modulation means is configured to apply, after the concentration phase, a higher pressure than the pressure applied during the concentration phase.

6. System according to claim 1, wherein the concentration area comprises an open diaphragm perpendicular to the central axis of flow of the viscoelastic fluid in the concentration area.

7. System according to claim 1, wherein the concentration area comprises a multitude of openings or capillaries parallel to the central axis of flow of the viscoelastic fluid in the concentration area.

8. System according to claim 1, wherein the concentration area comprises an angle, the central axis of flow of the viscoelastic fluid following said angle when passing through the concentration area.

9. System according to claim 1, that comprises a valve for orienting the viscoelastic fluid exiting from the concentration area to a choice of two directions, one of said directions leading to an instrument and/or a fraction collector.

10. System according to claim 1, wherein the concentration, pre-concentration by sample stacking and/or purification device comprises a concentration area having, in the direction of said flow, an intake channel and a plurality of outlet channels.

11. System according to claim 10, wherein the outlet channels are sized such that the average shear in the outlet channels is strictly greater than the average shear present in the intake channel of said device.

12. System according to claim 11, wherein the average shear ratio between the intake channel and each outlet channel of the concentration area is less than 0.01.

13. System according to claim 10, that comprises a multicapillary having linear channels, the concentration area being on one side of this multicapillary.

14. System according to claim 1, wherein the concentration area comprises a plurality of cones formed in a diaphragm perpendicular to the central axis of flow of the fluid exiting from the concentration area.

15. System according to claim 1, wherein the means for applying the electric field (E) is configured to apply a progressive decrease in the electric field after the concentration phase, for separating the molecules concentrated beforehand.

16. Kit for the operation of the system according to claim 1, that comprises the viscoelastic liquid.

17. Kit for the operation of the system according to claim 10, that comprises the concentration, pre-concentration by sample stacking and/or purification device, said device comprising a concentration area having, in a direction of flow, a plurality of outlet channels.

18. System according to claim 17, wherein the channels of the plurality of outlet channels are sized such that the average shear in these channels is at least double the average shear present in the intake channel of said device.
